(19) United States
(12) Patent Application Publication
(10) Pub. No.: US 2004/0091339 A1
(43) Pub. Date: May 13, 2004

(54) Multi-media picker assembly

(76) Inventors: Kevin Arnal, Chanhassen, MN (US); Andy Nelson, Hopkins, MN (US)

Correspondence Address: OPPENHEIMER WOLFF & DONNELLY LLP, 45 SOUTH SEVENTH STREET, SUITE 3300, MINNEAPOLIS, MN, 55402, US

(21) Appl. No.: 10/292,020

(22) Filed: Nov. 12, 2002

(51) Int. Cl. B65G 1/00

(52) U.S. Cl. 414/280

(57) ABSTRACT

A picker/placer is provided with the capability to handle multiple media types while also dealing with drives having various load profiles, all within the same data storage library. This is accomplished by providing the picker/placer with a picker assembly that has slider attached to the driving mechanism to allow lateral movement. Attached to the slider are a pair of picker fingers which are thus also compliant relative to the driving mechanisms of the picker/placer. This arrangement allows the picker fingers to deflect during advancement, whenever an interfering structure is encountered. Further, a compliant pusher assembly is included which provides over travel to deal with hard-stop loading drives, as well as auto-loading drives. Further, the floating picker fingers allows the picker assembly to work with various media types within the same library.

### BACKGROUND OF THE INVENTION

The present invention pertains to a picker/placer for media storage libraries. More particularly, the present invention provides a picker assembly for use in a storage library which is capable of manipulating multiple media types and is capable of cooperating with multiple storage drive types.

As is well known, data storage libraries are commonly used to manage and store high volumes of data. These storage libraries typically include at least one data storage drive, at least one picker/placer mechanism, and a number of storage compartments or storage slots. The multiple pieces of storage media are housed within the slots or compartments and are moved to the storage media drive on demand. When the drive has finished reading the desired data from the media, the picker/placer mechanism will simply remove that particular piece of media and move it back to an open storage compartment. Consequently, the media drive is available for accessing data on other pieces of storage media. Naturally, the storage library can be configured as needed for the particular application. Specifically, the storage library can include multiple storage drives and multiple storage compartments to increase storage and data handling capacity.

In the storage library industry, several different storage media types must be dealt with. Naturally, not all of these are compatible, however some limited cross-over does exist. For example, it is not practical to develop a library which would utilize both magnetic tape media and optical disk media within the same library. Existing media and drive designs make this overly complicated and not economically efficient.

Data storage media can often be classified within various media types such as magnetic tape, optical disk, magneto-optic, etc. Even within these same media families, it is difficult to manage multiple media types within a single library. In the tape storage area, multiple industry-wide standard data tape formats exist. Some examples include “DLT”, “SDLT”, and “LTO”. Each of these tape formats utilize a cartridge with different geometry and/or dimensions. Also, the tape within the cartridge is of a different format. This creates complications for a storage library, as picking and placing these different media types is difficult.

The operation of the drives themselves creates another level of design complication for the storage library designers. Obviously, the drive must be compatible with the particular media in the library. From a handling perspective, the loading profile of the drive must also be considered. Unfortunately, various drives load tape cartridges differently—some auto-loading and some hard-stop loading. A good example of an auto-loading device is a common VCR. When a videotape is inserted to a certain point in a VCR, a mechanism inside the VCR takes over and pulls the tape the rest of the way into the device. A drive that uses hard-stop loading does not pull the tape into the drive. Rather, the tape is mounted by external action. An example of this type of device is an eight-track cassette player. An eight-track cassette must be inserted fully and mounted into a cassette drive before it is played. However, one difference between an eight-track player and a hard-stop loading driver is the mounted position. When an eight-track cassette is fully inserted into a player, a portion of the eight-track cartridge remains exposed outside of the player. Conversely, when a tape is placed into a hard-stop loading drive, the outer edge of the cartridge often becomes flush with the front face of the drive. Naturally, variations on this may exist. Hard-stop loading drives do have a specific mount position which must be reached, however.

This distinction gives rise to another problem encountered by library systems. Like all manufactured products, dimensional and positional variances exist. Such variances would be rather inconsequential in a self loading drive as the picker/placer simply needs to insert the cartridge deep enough to be pulled away by the drive mechanism. However, for the hard-stop loading format, the picker/placer has the added difficulty of having to insert the cartridge completely into the drive to a mounted position. Any variations that exist in the mounting position of the various drives could result in damage to the picker/placer device, damage to the cartridge, damage to the drive, or a failure to engage the cartridge. For example, a first drive and a second drive may be positioned within the library such that their mounted positions are inconsistent. That is, one mounted position may be 1/16″ closer to the picker/placer than the other. Should the picker/placer attempt to mount a cartridge in this closer drive, stress results.

Thus, there is a need for a picker/placer device that can be used to manipulate data cartridges into and out of both self loading drives and hard-stop loading drives.

There is also a need for a picker/placer device that can compensate for variance in drive positioning. Specifically, the picker assembly can compensate for variance in the mounted position for various drives without causing damage to the cartridge, drive, or picker/placer.

In addition to dealing with the multiple drive types, there is a need for a picker/placer which can carry media cartridges of several different formats. Thus, the picker/placer could operate within a mixed media storage library. Obviously, due to the differences in cartridge geometry mentioned above, this creates a complication for the picker/placer mechanism. A desirable picker capable of handling these multiple cartridges would also be uncomplicated and relatively easy to fabricate. Consequently, such a picker/placer mechanism would be economical and reliable.

### BRIEF SUMMARY OF THE INVENTION

The present invention overcomes the aforementioned problems by providing a picker/placer mechanism that has a picker assembly capable of handling multiple types of media, and capable of interacting with several drive types. These capabilities are achieved by having the picker assembly include picker fingers which are independent of other structures, along with a pusher that has an appropriate amount of compliance or over travel to deal with differing load characteristics for various drives.

The picker assembly includes floating slider and a compliant pusher. The slider, which carries the picker fingers, is slideably attached to a transport mechanism. In order to move the picker assembly, the transport mechanism (in one embodiment, a lead screw nut interacting with a lead screw), causing linear movement into and out of a cavity of the picker/placer. As mentioned, the slider provides an attachment point for a pair of fingers that are used to grab and manipulate a data cartridge. The sliding relationship between the slider and the transport mechanism is preferably spring biased, and arranged to allow the slider to deflect when resistance is encountered by the fingers. This causes the picker fingers to float relative to the transport mechanism, while also providing the desired picking capabilities.

The floating picker fingers allow for the picking of various types of media cartridges. Although the picker fingers float relative to the lead screw nut, the picker fingers are spring loaded between picking and pushing positions. During picking operations, the picker fingers approach the cartridge in their picking or closed position. These fingers then surround the cartridge using the related spring bias. This arrangement allows for the picking of cartridge with different dimensions.

In order to deal with different load profiles for the various drives within the library, the above-mentioned compliant pusher is utilized. The compliant pusher is also slidably attached to the transport mechanism and is spring biased to a free position. This compliant pusher will thus move in conjunction with the transport mechanism when driven by the picker/placer.

As mentioned above, certain drives have a hard-stop loading characteristic. Further, the exact position of the these drives within the library can vary slightly. These two drive loading considerations (i.e., hard-stop loading and positional variance) create an additional complication for the media pusher. Specifically, if the media pusher attempted to push the media beyond the hard stop position of the media drive, damage would naturally result to either the pusher, media, or the drive.

The above-mentioned compliant pusher avoids this problem by providing compliance to deal with these positional variances. Specifically, when the drive position is such that the hard-stop is encountered prior to the end of transport mechanism, the compliant spring within the pusher will be compressed, thus avoiding damage to any components. Through this compliance, the pusher is provided with over travel capabilities, without the risk of damage.

In order to deal with various loading characteristics, the above-referenced floating picker fingers are also configured to slide when the front of a drive is encountered. Consequently, this picker finger design is also capable of interacting with both auto-loading and hard-stop loading drive types. In operation, the slider and attached picker fingers will deflect to a point which allows the compliant pusher to move its necessary travel distance. Also, the configuration of the picker fingers themselves further accommodate the placing of media by the picker assembly. Specifically, the configuration of the picker fingers causes them to clear or release the cartridge during any pushing operation. Thus, the picker fingers are not obstructing the loading operations, regardless of the drive's load profile.

One object of the present invention is to provide a multi-media picker assembly which is capable of picking and placing various media types. Specifically, the picker assembly can deal with media cartridges having differing automation features.

It is yet another object of the present invention to provide a picker assembly which is capable of interacting with multiple drive types, including both auto-loading drives and hard-stop loading drives.

It is a further object of the present invention to provide a picker assembly that is capable of loading hard/stop loading drives without damaging either the media cartridge, the picker assembly, or the drive itself.

It is yet a further object of the present invention to provide a picker assembly for use in a storage library that accommodates multiple media types, and multiple drive types with different geometry, load points, and load profiles.

### BRIEF DESCRIPTION OF THE DRAWINGS

Further objects and advantages of the present invention can be seen from reading the following detailed description, in conjunction with the drawings in which:

FIG. 1 is a perspective view of the picker/placer device of the present invention;

FIG. 2 is a plan view of the picker assembly of the present invention;

FIG. 3 is a plan view of the picker assembly of the present invention with the slider in a displaced position;

FIG. 4 is a perspective view of the pusher of the present invention;

FIG. 5 is a cross-sectional view of the picker assembly along section lines 5-5 of FIG. 2; and

FIG. 6 is a top view of picker assembly 12 with the picker fingers in their closed position.

### DETAILED DESCRIPTION OF THE INVENTION

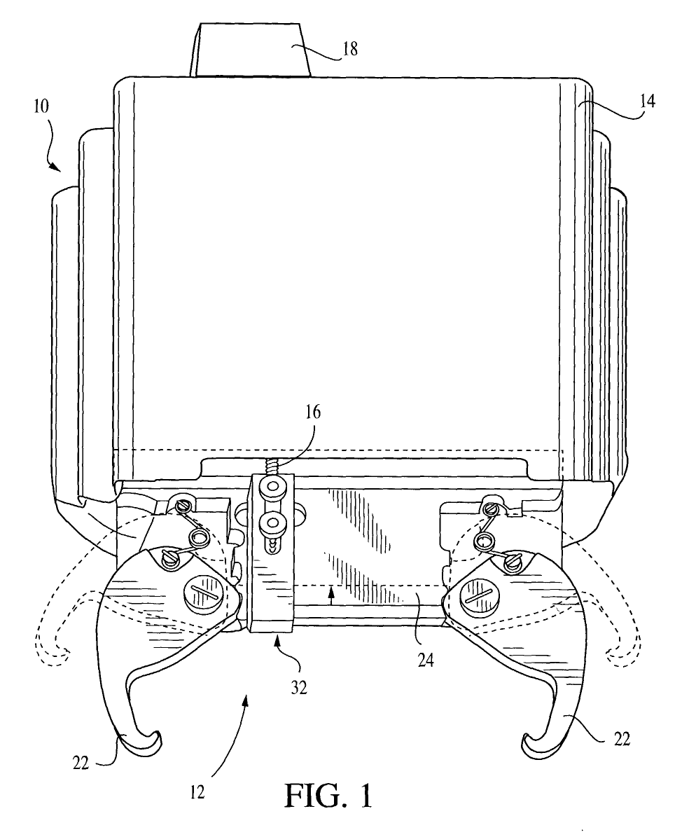

Referring now to FIG. 1, there is shown a perspective front view of one embodiment of a picker/placer 10. Picker/placer 10 includes a picker assembly 12, a housing 14, a transport mechanism 16 and a motor 18. Picker assembly 12 is coupled to transport mechanism 16, which is a lead screw 16 and lead screw nut 28 in this embodiment, to allow movement into and out of housing 14. Lead screw 16 is driven by motor 18. In turn, motor 18 is controlled by a picker/placer controller (not shown).

Picker assembly 12 includes a pair of picker fingers 22 pivotally attached to a slider. As described in further detail below, slider 24 is coupled to the transport mechanism 16 via attachment to a driven member, or lead screw nut 28 in a manner that allows for translation or movement of these two parts relative to one another. Picker assembly 12 further includes a media pusher 32 that is also attached to lead screw nut 28. Similar to the slider 24, media pusher 32 is also slidably attached to lead screw nut 28 to allow some movement of these two parts relative to one another.

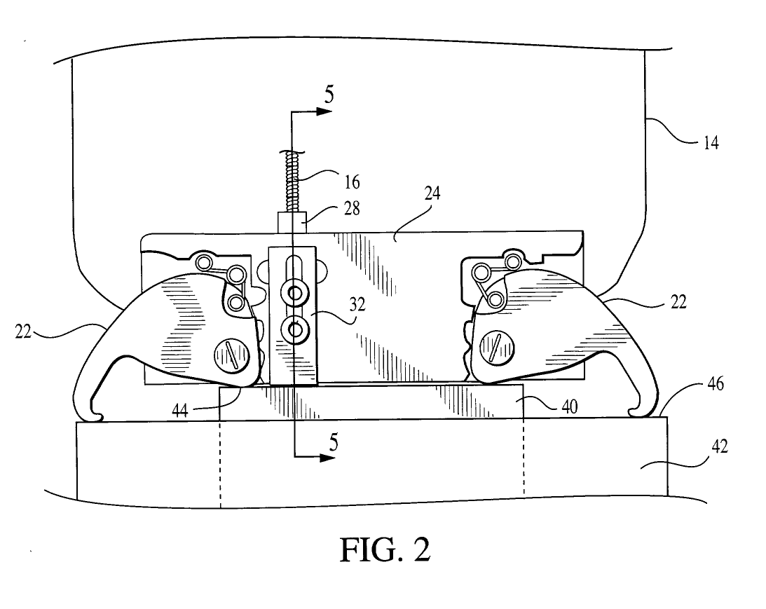

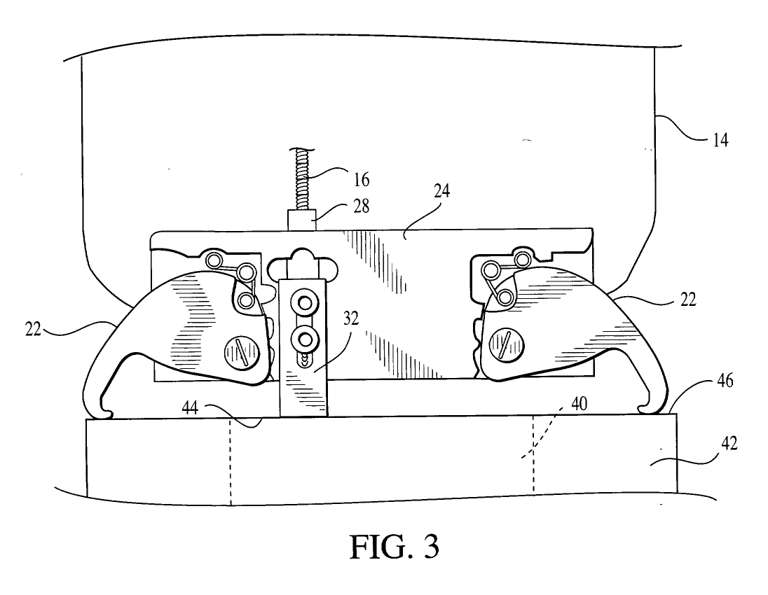

As mentioned above, various drives have different load profiles which must be dealt with by the design and configuration of picker assembly 12. Specifically, picker assembly 12 is capable of operating with drives having either a hard-stop loading profile or an auto-loading profile. From the perspective of picker assembly 12, the auto-loading profile is much easier to deal with as drive mechanisms simply take over the movement of the media cartridge once a certain point is achieved. Hard-stop loading drives create a further complication however, as the picker assembly 12 is solely responsible for moving the media cartridge to the mounted position. Referring now to FIGS. 2 and 3, the placing or insertion of a media cartridge 40 into a media drive 42 is further illustrated. In this example, drive 42 is a hard-stop loading drive which requires the media cartridge 40 be pushed to a seated or mounted position wherein the edge 44 of media cartridge 40 is flush with the front face or bezel 46 of media drive 42

As shown in FIG. 2, picker/placer 10 has been positioned adjacent to the media drive 42 and has advanced picker assembly 12 to allow media cartridge 40 to be partially inserted into drive 42. At this point during the movement of picker assembly 12, picker fingers 22 will encounter the front face 46 of media drive 42. Due to the slidable relationship between lead screw nut 28 and slider 24, this interference of picker fingers 22 will cause movement of these elements relative to one another. More specifically, as lead screw nut 28 advances, slider 24 and attached picker fingers 22 will remain at their current positions due to the interference with drive face 46. However, media pusher 32 will continue moving along with lead screw nut 28, thus advancing cartridge 40. This movement of media pusher 32 will continue to a loading point as is shown in FIG. 3. At this loading point, the media cartridge 40 has been fully inserted into drive 42.

Once again, drive 42, in this example, has a hard-stop loading profile, thus when cartridge 42 reaches its mounting position, it will encounter physical stops within the drive itself (not shown). Consequently, the positional alignment and control of picker assembly 12 is very important so as to avoid damage to the various components. Once again, however, media pusher 32 and lead screw nut 28 are attached to one another in a compliant manner to avoid the potential for damage.

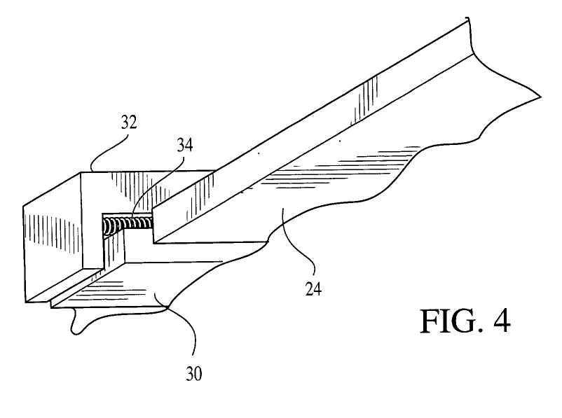

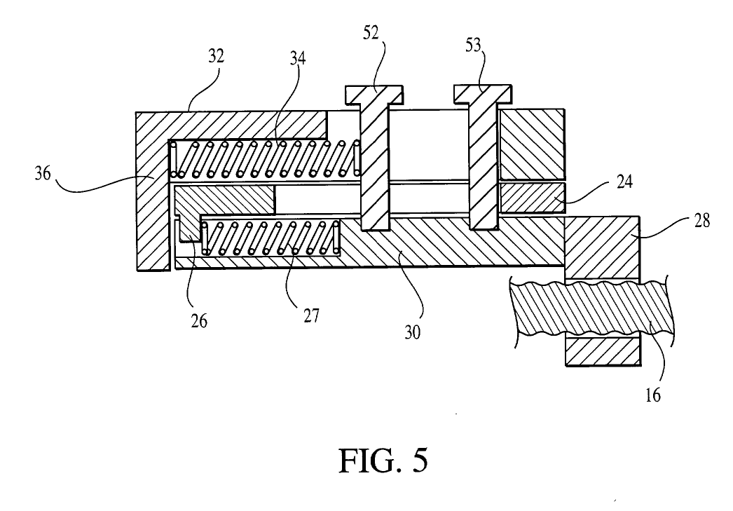

Referring to FIG. 4, this relationship is better illustrated. More specifically, FIG. 4 illustrates a bottom view of pusher element 32 and related components. Also illustrated are portions of a stage 30, which is attached to a lead screw nut 28, and a pusher spring 34 which provides compliance. To better illustrate the relationship of these components, FIG. 5 is a cross-sectional view of picker assembly 12 at section 5-5 shown in FIG. 2. As can be seen in FIG. 5, lead screw nut 28 is specifically designed to interact with lead screw 16. Attached to lead screw nut 28 is a stage 30 which extends outwardly away from lead screw nut 28. Stage 30 is specifically configured to interact with the other components of picker assembly 12. It should be noted that lead screw nut 28 and stage 30 could easily be combined into one part, such as a molded plastic piece. A pair of attachment screws 52 and 53 are rigidly attached to stage 30, and consequently will move in conjunction with lead screw nut 28.

Media pusher 32 is slidably attached to lead screw nut 28 via a spring 34. Specifically, spring 34 has one side attached to or resting against screw 52 while the other side is attached to or resting against a downwardly extending portion 36. Pusher 32 is retained in its normal position (shown in FIG. 5) by attachment screws 53 acting against the force generated by spring 34. A force acting against spring 34 (i.e., force on downwardly extending portion 36) will cause movement of pusher 32, if that force is strong enough to overcome the force supplied by spring 34.

Also shown in FIG. 5 is slider 24 which is also slidably coupled to lead screw nut 28. Specifically, slider 24 includes a downwardly extending notch 26 which is specifically designed to interact with a slider spring 27. Slider spring 27 also interacts with stage 30 at an internal surface thereof. This configuration allows the slidably coupled relationship between slider 24 and stage 30. Slider 24 is held in its normal or static position (as shown in FIG. 5) by attachment screw 53 acting against the spring force provided by slider spring 27. Once again, any force applied to slider 24 will cause compression of slider spring 27 and appropriate translation relative to lead screw nut 28.

As stage 30 and lead screw nut 28 are rigidly attached to one another, stage 30 will move along with lead screw 28. Through the use of transition plate spring 27 and pusher spring 34, the multiple levels of compliance for the picker assembly of the present invention is achieved. Naturally, the spring characteristics must be appropriately chosen to achieve the desired results. Typically, this involves the use of a relatively stronger spring for pusher spring 34 and a somewhat lighter spring for transition plate 27.

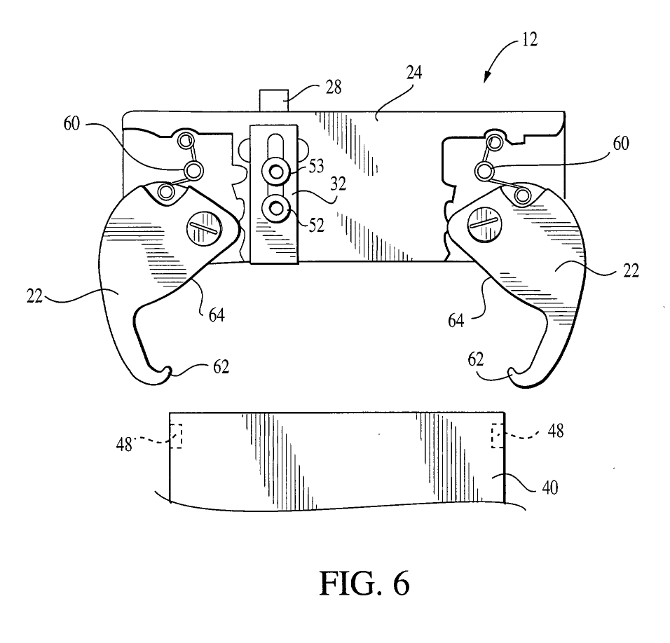

As mentioned above, the picker assembly 12 of the present invention accommodates the handling of various media types. This flexibility is achieved by the use and design of the floating picker fingers 22, as described above. Referring now to FIG. 6, the picker fingers are illustrated in their closed or picking position. In this condition, the fingers are closed and approaching media cartridge 40. Picker fingers 22 each include a picker finger spring 60 which is positioned and configured to operate the picker finger in a dual state mode. More specifically, in the closed position, the spring is configured to resist certain amounts of force and bias of the tips 62 of picker fingers 22 inwardly. Once picker fingers 22 reach a certain point, the spring will snap picker fingers 22 into their open position, such as that shown in FIG. 2. When used for picking however, the springs allow picker finger tips 62 to surround media cartridge 40 and eventually interact with slots 48 in media cartridge 40.

Once in the these slots, picker finger tips 62 will allow picker assembly 12 to pull the media cartridge within housing 14 of picker/placer 10. Once inside housing 14, picker/placer 10 can then move the media cartridge 40 to another location within the library and appropriately place it in a desired location.

It should also be noted, that the configuration of picker fingers 22 causes them to clear media cartridge 40 anytime picker assembly 12 is pushing. Specifically, a sloped portion 64 of picker fingers 22 will encounter cartridge 40 anytime pushing operations are undertaken. Due to the sloped configuration, a force will be generated against picker finger 22 causing them to rotate out of interference with cartridge 40. This allows other components, such as pusher 32 to take over and complete a cartridge placing operation.

The above discussion illustrates one embodiment of the present invention. Naturally, certain variations can be made which do not effect the scope or operation of the invention. For example, several alternative transport mechanisms could be used in place of the lead screw 16 and associated lead screw nut 28 discussed above. For example, a coupling block could be attached to a belt drive for moving the picker assembly 12. Also, a motor and related drive gear could cooperate with a gear rail attached to the housing in order to move picker/placer appropriately. Several other alternatives exist. It is simply necessary to have a transport mechanism that includes a driven member that is moved to different locations within the housing. Further, the driven member must be adapted to allow the coupling of the pusher and slider assemblies to allow the necessary levels of compliance.

Those skilled in the art will further appreciate that the present invention may be embodied in other specific forms without departing from the spirit or central attributes thereof. In that the foregoing description of the present invention discloses only exemplary embodiments thereof, it is to be understood that other variations are contemplated as being within the scope of the present invention. Accordingly, the present invention is not limited in the particular embodiments which have been described in detail therein. Rather, reference should be made to the appended claims as indicative of the scope and content of the present invention.

What is claimed is:

1. A picker/placer for use in data storage library capable of handling multiple media types and having multiple drive types, the picker/placer comprising:
a housing capable of being transported throughout the storage library;
a transport mechanism coupled to the housing having a driven member;
a picker assembly coupled to the transport mechanism so as to allow movement of the picker assembly into and out of the housing, the picker assembly further having a pair of floating picker fingers and a pusher member, the floating picker fingers capable of deflecting during advancement of the driven member, the pusher further being capable of deflecting during advancement of the driven member, thus allowing for over travel of the driven member when pushing the media into a drive.

2. The picker/placer of claim 1 wherein the floating picker fingers are attached to a slider, the slider being coupled to the driven member via a slider spring, the slider also capable of deflecting when the driven member is advanced, thus providing the floating nature of the picker fingers.

3. The picker/placer of claim 1 wherein the pusher is coupled to the driven member by a pusher spring, the pusher spring being compressed to provide compliance to the pusher and allowing for over travel of the driven member.

4. The picker/placer of claim 2 wherein the slider spring is capable of being compressed if the picker fingers encounter interference while the driven member is being advanced.

5. The picker/placer of claim 4 wherein the picker fingers are rotatably attached to the slider and are biased between an open position and a closed position, the picker fingers being positioned so as to allow the picker assembly to grab the media when the picker fingers are in the closed position, the picker fingers further configured to be clear from the media while pushing the media into the drive.

6. The picker/placer of claim 1 wherein the driven member is a lead screw nut and the transport mechanism is a lead screw attached to the housing which is controlled by a motor.

7. The picker/placer of claim 1 wherein the transport mechanism is a belt driven by a motor.

8. The picker/placer of claim 7 wherein the driven member is an attachment block attached to the belt.

9. The picker/placer of claim 1 wherein the transport mechanism comprises a gear track rigidly attached to the housing, and a cooperating drive gear driven by a motor, the drive gear attached to a driven member so as to provide linear motion to the driven member.

10. A picker assembly capable of being coupled to a driven member of a transport mechanism of a picker/placer which causes translational movement of the picker assembly, the picker assembly further capable of operating within a library environment in which the picker assembly may encounter interference during the placement of a storage media within a drive, the picker assembly comprising:
a pusher coupled to the driven member via a pusher spring, the pusher biased in its normal position by the pusher spring but is capable of movement relative to the driven member if opposing force is encountered by allowing compression of the pusher spring;
a slider coupled to the driven member via a slider spring, the slider biased in its normal position by the slider spring but is capable of movement relative to the driven member if opposing force is encountered by allowing compression of the slider spring; and
a pair of picker fingers rotatably attached to the slider such that the picker fingers further capable of sliding with the slider if rigid objects are encountered during the advancement of the driven member.

11. The picker assembly of claim 10 wherein the picker fingers are rotatable between an open position and a closed position,

12. The picker assembly of claim 11 wherein the picker fingers are configured to rotate to the open position during advancement of the driven member.

13. The picker assembly of claim 12 wherein the picker fingers are each biased to either the open position or the closed position via a finger spring.

14. A picker/placer for use within a storage library, comprising:
a housing capable of being transported throughout the storage library:
a picker assembly for picking and placing storage media, the picker assembly comprising a pusher, a slider and a pair of picker fingers, wherein the picker fingers are rotatably attached to the slider; and
a transport mechanism coupled to the picker assembly and associated with the housing so as to cause movement of the picker assembly into and out of the housing, the transport mechanism being slidably attached to the picker assembly so as to allow independent translational deflection of both the slider and the pusher relative to the drive mechanism.

15. The picker/placer of claim 14 wherein the pusher is slidably coupled to a driven member of the transport drive mechanism, the pusher being biased to a normal position via a pusher spring.

16. The picker/placer of claim 14 wherein the slider is slidably coupled to a driven member of the transport drive mechanism, the slider being biased to a normal position via a slider spring.

17. The picker/placer of claim 14 wherein the transport mechanism includes a driven member which is translated within the housing.

18. The picker assembly of claim 17 wherein the driven member is a lead screw nut and the transport mechanism includes a cooperating lead screw.

19. The picker assembly of claim 18 wherein the lead screw is attached to a motor such that the motor causes rotation of the lead screw resulting in movement of the lead screw nut.

20. The picker assembly of claim 18 wherein the lead screw nut is attached to and driven by a motor and the lead screw is attached to the housing such that driving of the lead screw nut causes movement of the lead screw nut within the housing.

21. The picker assembly of claim 17 wherein the transport mechanism includes a belt driven by a motor.

22. The picker assembly of claim 21 wherein the driven member is an attachment block attached to the belt and the belt is driven by a motor.

23. The picker assembly of claim 21 wherein the belt is attached to the housing, and the driven member is a motor housing, wherein the operation of the motor causes movement of the motor housing.

24. The picker assembly of claim 17 wherein the drive mechanism comprises a gear track rigidly attached to the housing, and a cooperating drive gear driven by a motor, the drive gear attached to a driven member so as to provide linear motion to the driven member.

25. The picker assembly of claim 17 wherein the driven member comprises a gear track which cooperates with a drive gear driven by a motor, the drive gear and motor attached to the housing so as to provide linear motion to the driven member.
